(19) United States
(12) Patent Application Publication
(10) Pub. No.: US 2010/0175661 A1
(43) Pub. Date: Jul. 15, 2010

(54) INTERNAL COMBUSTION ENGINE

(76) Inventor: R. Kirk Collier, JR., Sparks, NV (US)

Correspondence Address: CHRISTIE, PARKER & HALE, LLP, PO BOX 7068, PASADENA, CA, 91109-7068, US

(21) Appl. No.: 12/447,430

(22) PCT Filed: Oct. 29, 2007
(86) PCT No.: PCT/US07/82908

§ 371 Date: Mar. 16, 2010

Related U.S. Application Data
(60) Provisional application No. 60/854,914, filed on Oct. 27, 2006.

(51) Int. Cl. F02B 31/00; F02B 43/00; F02F 3/00

(52) U.S. Cl. 123/306; 123/527; 123/193.6

(57) ABSTRACT

A method of operating an internal combustion engine for the purposes of producing significantly lower NOx emissions than currently achieved without exhaust aftertreatment is described. The engine is equipped with an intake system and combustion chamber that minimizes overall in-cylinder angular momentum of the air fuel charge. The engine is fueled with a gaseous fuel such as natural gas. The purpose of the intake system and combustion chamber is to create low combustion peak temperature while keeping the overall average temperature the same. Charge dilution which can be in the form of excess combustion air, recirculated exhaust gases, water injection, or combinations of all three will be used to assist in reducing NOx emissions.

### FIELD OF THE INVENTION

This invention relates to gaseous fuel powered internal combustion engines that produce exhaust gas having near-zero emissions of oxides of nitrogen (NOx.)

### BACKGROUND OF THE INVENTION

Internal combustion engines are commonly used in motor vehicles as well as for other purposes such as power generation. In the last few decades, federal and state regulatory agencies have encouraged engine manufacturers to produce cleaner burning engines.

Reduced vehicle emissions have been achieved largely due to modifications in the engine design, with some modifications to the traditional hydrocarbon fuels. More recently, federal and state agencies have been encouraging the use of alternative fuels, particularly, gaseous fuels such as methane or natural gas, propane and butane. In general, such gaseous fuels tend to burn cleaner than conventional hydrocarbon fuels. However, the combustion of such fuels can still tend to produce a significant amount of emissions of oxides of nitrogen (NOx.)

In order to reduce NOx emissions, some engine manufacturers have designed engines in which additional gases are introduced into the fuel stream to dilute the fuel charged into the combustion chamber. Such dilution tends to reduce the flame temperature, thereby reducing NOx emissions. Common methods of diluting the charge include the addition of excess air to the air-fuel mixture charged to the combustion chamber to operate under “lean-burn” conditions, the use of exhaust gas recirculation (EGR), water injection, or combinations of the three. The term “excess air” is intended to mean an amount of air in excess of the stoichiometric amount necessary to support complete combustion of the fuel. The use of charge dilution results in an increase in the heat capacity of the gases used in the combustion process. The increase in heat capacity in turn reduces the peak temperature of the combustion process. By sufficiently reducing the peak temperature, NOx emissions can be significantly reduced.

One problem with operating an engine at high charge dilution is that for some fuels, the charge mixture can become too lean to support complete combustion, resulting in a “misfire” condition. Misfire not only results in a severe drop in engine efficiency, but also results in high emissions of unburned hydrocarbons in the engine exhaust. Consequently, while high levels of charge dilution are desired to produce low NOx emissions, near-zero NOx emissions are difficult to achieve because of misfire.

Another factor that must be considered when designing an engine to operate at high levels of charge dilution is that good mixing of the mixture charged to the combustion chamber is critical for both efficient combustion and low emissions. Without good mixing, “hot spots” can develop in certain areas within the combustion chamber causing an increase in NOx emissions. The most common means of achieving good mixing is through engine design whereby high levels of internal angular momentum are imparted to the charge mixture as it is introduced into the combustion chamber. Such high levels of angular momentum generally promote turbulent mixing of the air-fuel mixture, thereby promoting faster combustion flame speeds in highly diluted mixtures. For liquid fuels such as gasoline, the high angular momentum further promotes the vaporization of the fuel.

Currently there are two commonly used methods for generating high angular momentum in the charge mixture. The first method is to configure the engine intake ports and/or the intake valves relative to the engine cylinder so that the charge mixture circulates within the cylinder. The object of this method is to sustain an overall circular motion within the cylinder until the piston reaches the bottom of its travel during the intake stroke. As the cylinder moves upward in the cylinder on the compression stroke, the remaining circular motion of the charge mixture is amplified by the decreasing volume in the cylinder. The resulting circular or vortex motion of the charge mixture at the point of initial combustion can be quite high causing excellent mixing for a charge mixture composed of hydrocarbons, air and recycle gases. In one type of intake port design, the intake port has a shallow angle of flow relative to the valve face in order to generate a significant flow velocity in a plane perpendicular to the cylinder centerline. According to another intake port design, a helical port is used to impart a vortex motion to the charge before it reaches the intake valve. Intake valves can also be designed with shrouds to cause unequal flow about the intake valve to generate a vortex flow within the engine cylinder. Furthermore, multiple intake valves can be used whereby the valves introduce the charge mixture into the combustion chamber in different directions to promote vortex flow.

The second method for generating high angular momentum in the charge mixture is through combustion chamber design. Rapidly moving circular vortices in the charge mixture can be promoted by designing the shape of the combustion chamber to cause high angular momentum, especially during the compression cycle. This is commonly achieved by the piston crown design. Commonly used piston crowns designed to promote vortex flow include the “bathtub” design, “bowl-in-piston” design, “nebula” design, “reentrant” design, and the “TG” design.

Cylinder head designs can also be used to modify the shape of the combustion chamber, thereby contributing to high angular momentum within the cylinder. For example, cylinder heads can be designed with shrouds similar to intake valve shrouds, or with a “chamber-in-head” design, either of which will cause unequal flow about the intake valve, resulting in the generation of vortex flow within the combustion chamber. Any of these designs, or combinations of the designs can be used to promote vortex flow within the combustion chamber.

Regardless of whether either of these methods or some other method is used to achieve high angular momentum within the combustion chamber, two types of angular momentum are generally recognized. The first is where the circular motion within the combustion chamber is generally about an axis defined by the centerline of the engine cylinder. This type of angular momentum is called “swirl.” The second is where the circular motion within the combustion chamber is generally about an axis perpendicular to the axis defined by the centerline of the engine cylinder. This type of angular momentum is called “tumble.”

The use of “swirl ratio” and “tumble ratio” are useful in quantifying the levels of such turbulence or angular momentum within the engine. The “swirl ratio” is defined as the dimensionless ratio between the rotational speed of the swirl vortex divided by the engine speed, both measurements being typically expressed in revolutions per minute. Similarly, the “tumble ratio” is defined as the dimensionless ratio between the rotational speed of the tumble vortex divided by the engine speed.

For lean-burn engines operating on natural gas and other gaseous hydrocarbons, maintaining good mixing of the charge mixture such as by using a combustion chamber with high levels of swirl and tumble has generally been considered critical for preventing incomplete combustion and maintaining low NOx emissions.

### SUMMARY OF THE INVENTION

In one embodiment of the invention, an internal combustion engine runs on a gaseous fuel under diluted charge conditions to produce low NOx emissions. The gaseous fuel is selected from methane, natural gas, propane, butane and combinations, and is mixed with air and fed into a substantially quiescent combustion chamber of the internal combustion engine at a substantially low angular momentum to prevent significant swirl or tumble. In the combustion chamber, fuel-air mixture is then combusted within the combustion chamber. The result is an exhaust gas stream with very low NOx emissions.

In one embodiment the angular momentum of the fuel-air mixture that is introduced into the combustion chamber has a swirl ratio less than about 1. In still another embodiment, the fuel-air mixture that is introduced into the combustion chamber has a swirl ratio of about 0.5.

In still another embodiment the diluted charge conditions are achieved by mixing the fuel and air with a diluent selected from excess air, recirculated exhaust gas, water vapor, and combinations.

In another embodiment of the invention, an internal combustion engine includes an intake manifold adapted to mix a gaseous fuel selected from the fuels consisting of methane, natural gas, propane, butane and combinations, with air and a recycled exhaust gas stream to produce an diluted charge fuel mixture. The internal combustion engine further includes at least one combustion chamber adapted to receive the diluted charge fuel mixture from the intake manifold, burn the fuel, and produce an exhaust gas stream from the combustion chamber through an exhaust gas conduit. For this embodiment, the intake manifold and combustion chamber are designed to maintain a substantially low angular momentum for the air-fuel mixture within the combustion chamber. According to an embodiment, at least a portion of the exhaust gas stream is recycled to the intake manifold in order to dilute the fuel-air mixture.

According to another embodiment, the combustion chamber is defined by a piston, a cylinder, and a cylinder head. In other embodiment, a plurality of combustion chambers are provided.

In still another embodiment, a plurality of combustion chambers are provided as a plurality of cylinders with corresponding pistons and at least one cylinder head. Each cylinder may include at least one intake port through the cylinder head, the engine further comprising an intake valve corresponding to each intake port, each intake valve including a valve stem. Each intake port may be defined by at least one port wall substantially parallel to the corresponding valve stem. Such a design is useful for maintaining quiescent conditions within the combustion chamber.

In still other embodiments, each piston may define a flat piston crown or a dished piston crown. Such piston crowns may also be substantially symmetrical about a central axis of the corresponding cylinder. Such designs are also useful in maintaining quiescent conditions within the combustion chamber.

### BRIEF DESCRIPTION OF THE DRAWINGS

These and other features and advantages of the present invention will be better understood by reference to the following detailed description when considered in conjunction with the accompanying drawings wherein:

FIGS. 1 and 2 are side views of exemplary piston crown shapes useful in practicing methods of the present invention; and

FIG. 3 is a generally schematic side view in section of an embodiment of a piston cylinder of the present invention.

### DETAILED DESCRIPTION

A novel approach to constructing and operating an internal combustion engine combines the high efficiency and long engine life of lean burn combustion with significantly reduced NOx emissions. The invention may be applied to any application for internal combustion engines whether stationary or vehicular. The invention can be applied to different types of internal combustion engines, including without limitation, reciprocating piston engines, Wankel engines and gas turbine engines. The engine may be single cylinder, multiple cylinder, or of a combustor design. The engine may operate with or without regenerative heating of the combustor. The engine may be naturally aspirated, or can use an external compression device such as a turbocharger or supercharger. The invention has particular utility when used with compression ignition engines operating on a gaseous fuel such as methane, natural gas (a blend of methane and higher order hydrocarbons,) propane, butane and combinations. In one embodiment, natural gas is the gaseous fuel.

The combustion of a gaseous fuel and air inside and internal combustion engine involves a balancing of a number of competing factors which may include combustion turbulence, the charge dilution that the combustion process will tolerate for efficient operation, the amount of NOx emissions produced, the amount of hydrocarbon emissions produced, and the engine thermal efficiency. High levels of combustion turbulence tend to create a faster flame front that will allow higher values of charge dilution which can result in lower NOx emissions. However, it has been discovered that high levels of combustion turbulence can also increase peak combustion temperature causing increased NOx emissions. Furthermore, the faster flame speed of turbulent combustion will reduce ignition timing advance which can improve thermal efficiency, but it will also increase heat transfer to the cylinder walls which decreases thermal efficiency.

Applicant has unexpectedly discovered that NOx emissions from an engine can be reduced significantly by operating the combustion chamber under quiescent conditions with little turbulence. Such quiescent combustion conditions can be achieved through the proper design of the intake system and the combustion chamber.

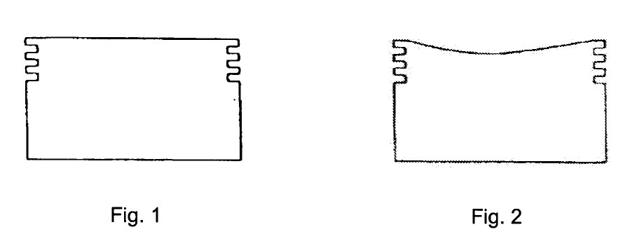

Examples of preferred piston crown shapes are shown in FIGS. 1 and 2. The flat-top design, shown in FIG. 1, and the dish design, shown in FIG. 2, generally tend to avoid imparting any significant preferential motion within the charge mixture that would result in a net angular momentum of the charge mixture in the combustion chamber.

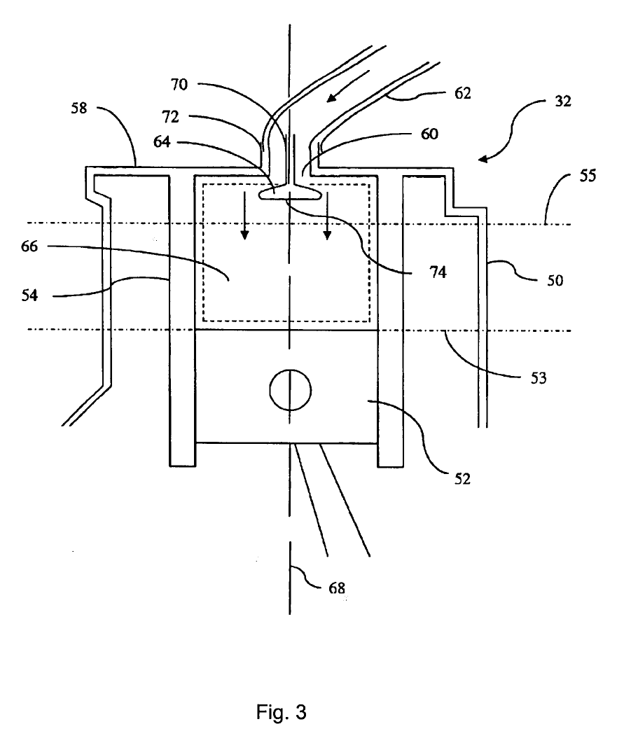

A preferred intake port and combustion chamber design is illustrated somewhat schematically by FIG. 3. There, the engine 32 includes an engine block 50 that contains at least one piston 52 that reciprocally translates within a cylinder 54 between a first position 53, referred to as bottom dead center (BDC) and a second position 55, referred to as top dead center (TDC). The top of the cylinder is enclosed by a cylinder head 58, which includes an intake port 60 which passes the air-fuel mixture from the intake manifold 62 into the engine. An intake valve 64 is positioned at the intake port to regulate the air-fuel mixture passing from the intake manifold to the engine. Those skilled in the art will appreciate that internal combustion engines generally include both intake and exhaust valves, but only an intake valve is depicted in FIG. 3 to simplify the description of the exemplary engine. The top of the piston, the engine head and the interior wall of the cylinder together define a combustion chamber 66 in which the charge mixture is compressed and ignited.

As illustrated by FIG. 3, the combustion chamber is preferably symmetrical about a longitudinal axis 68 extending though the center of the piston cylinder. To maintain a “quiescent” environment, the intake valves are not “shrouded,” nor is there any significant low clearance section relative to the piston crown at TDC that could generate significant overall vortices in the combustion chamber.

The combustion chamber should be as symmetrical as possible with no “shrouding” of the intake valve and no significant low clearance sections relative to the piston crown at the top of its motion in the cylinder that could generate significant overall vortices in the combustion chamber. The intake ports should be directed into the engine cylinder as concentric and as parallel as possible to the intake valve stem and with no rotational orientation with respect to the intake valve stem.

The intake port is preferably designed such that the flow of the charge mixture passing into the combustion chamber is concentric and parallel to the cylinder walls and intake valve stem 70. To obtain charge flow parallel to the intake valve stem, the section of the intake port adjacent to the intake valve face preferably includes a straight section with port walls 72 parallel to the valve stem and perpendicular to valve face 74.

A small amount of valve cant relative to the cylinder centerline may be incorporated to allow clearance between the cylinder wall and the valve face such that the flow of the charge mixture is not significantly impeded by the cylinder wall. Furthermore, localized vortices are nearly impossible to avoid in conventional internal combustion engines. Thus, merely flowing charge mixture past a poppet intake valve will create localized vortices about the valve edges. Therefore, while such localized vortices may be found in embodiments of the present invention, the goal is to eliminate large generalized vortices within the combustion zone of an internal combustion engine. Moreover, according to an embodiment of the invention, the vector sum of unavoidable, small, and incidental vortices within the combustion chamber is near zero.

In an embodiment of the invention, the air-fuel ratio of the engine is operated at a phi value of 0.61 where phi is defined as a fraction of the stoichiometric fuel ratio on a weight basis. In other words, a phi value of 1.0 represents a stoichiometric air-fuel ratio, while a phi value of 0.5 represents double the stoichiometric quantity of air on a weight basis.

It has been determined that a phi value of about 0.61 is the optimum phi value for an engine operating according to the present invention. This air fuel ratio results in the best tradeoff between NOx and hydrocarbon emissions given that an oxidizing catalyst can reduce hydrocarbon emissions and the relative costs of the catalyst size and technology required to give that reduction. The high swirl cylinder head engine can generally operate at a phi value that is about 0.02 below that of the quiescent head engine. This phenomenon is consistent with theoretical considerations. However, NOx emissions are still about 30% higher with the high swirl cylinder head than with the quiescent cylinder head with similar hydrocarbon emissions. Therefore, even though this high combustion turbulence created by the high swirl cylinder head can extend the lean limit of combustion relative to quiescent combustion, it is not sufficient to offset the increased NOx emissions due to the inherently faster flame speed.

However, while a phi value of 0.61 may be considered optimal, operating at a phi value lower than this can result in misfire. Therefore, due to inaccuracies in the O₂ sensors typically used in engines, especially due to inaccuracies that develop over the life of the engine, a phi value of 0.63 provides a sufficient margin to generally provide sufficiently low NOx emissions while preventing a misfire condition.

Tests were conducted on an 11 liter, six cylinder, compression ignition engine fueled with commercial natural gas at a phi value of 0.63. Two different intake port designs were tested with widely differing swirl characteristics. The first port design was of a design imparting highly turbulent combustion conditions, and is of a type commonly used in modern, commercially available heavy-duty engines. The swirl ratio imparted by this turbulent intake port was measured as 2.3. The second port design was created specifically for quiescent combustion as set forth above. The swirl ratio imparted by this quiescent intake port was measured as 0.4. Emissions were tested using the 13-Mode European Stationary Cycle Emissions (EMC13) test procedure which is designed to simulate a transient drive cycle with a series of steady state operating conditions at varying throttle settings and engine speeds.

The results of these tests are shown in Tables 1 and 2. Table 1 shows exhaust emissions and engine efficiency for wide open throttle and varying engine speed for the two engine designs. Table 2 shows emissions results for the ESC 13 test.

TABLE 1
Wide Open Throttle Testing (Phi = 0.63)

| | Engine | Emissions (g/hp-hr) | | |
|---|---|---|---|---|
| Port Type | Speed (rpm) | NOx | THC | BSFC |
| Quiescent | 1000 | 0.21 | 1.62 | 146 |
| High Swirl | 1000 | 1.55 | 1.61 | 140 |
| Quiescent | 1200 | 0.30 | 2.03 | 147 |
| High Swirl | 1200 | 1.96 | 1.59 | 142 |
| Quiescent | 1400 | 0.41 | 2.01 | 148 |
| High Swirl | 1400 | 2.12 | 1.13 | 142 |
| Quiescent | 1600 | 0.47 | 1.92 | 150 |
| High Swirl | 1600 | 2.88 | 0.95 | 143 |
| Quiescent | 1800 | 0.55 | 2.04 | 152 |
| High Swirl | 1800 | 3.04 | 0.96 | 145 |
| Quiescent | 2000 | 0.54 | 1.95 | 155 |
| High Swirl | 2000 | 3.37 | 0.88 | 148 |
| Quiescent | 2200 | 0.59 | 1.85 | 160 |
| High Swirl | 2200 | 4.29 | 0.81 | 153 |

TABLE 2
EMC13 Emissions Test Results (in g/hp-hr)

| Exhaust Component | Quiescent Intake | High Swirl Intake |
|---|---|---|
| NOx | 0.354 | 1.617 |
| THC | 2.143 | 0.910 |

These results show that there are trade-offs between the quiescent intake (swirl=0.4) and the turbulent intake (swirl=2.3). Referring to Table 1, turbulent induction results in higher efficiency as shown by the brake specific fuel consumption (BSFC,) a corresponding increase in torque, and lower total hydrocarbon (THC) emissions. However, it was confirmed that these benefits come at the expense of higher NOx emissions as the testing showed that the quiescent intake port offered dramatic reductions in NOx emissions.

The increased thermal efficiency of the high swirl intake is the result of relatively faster flame speed. With higher flame speed comes less ignition advance. As the flame speed is reduced, the ignition advance must be increased for maximum efficiency. The period of rotation of the crankshaft between the ignition initiation and top dead center for the piston to begin the power stroke represents negative work by the engine. Therefore, this negative work subtracts from the positive work provided by the piston movement after top dead center. These data show that this effect is larger than the negative effect of higher thermal losses through the cylinder wall for the high swirl intake. This is the major reason that high swirl intake systems are universally used where fuel economy is of great importance. However, given current air quality regulations, fuel economy is not always the major goal for internal combustion engines. The emissions of oxides of nitrogen are the regulatory constraint that must be met before these engines can be used.

It is generally accepted that even though a high swirl intake generates a high flame speed concomitant to higher NOx emissions, the lean limit of combustion can be increased such that leaner engine operation will result in lower NOx emissions. Tables 1 and 2 disprove that notion. The result is that surprisingly reduced NOx emissions are achieved by quiescent combustion rather than by turbulent combustion.

Without being bound by theory, it is believed the increased thermal efficiency of the high swirl intake is the result of relatively faster flame speed. With higher flame speed, there is less ignition advance. However, as the flame speed is reduced, the ignition advance must be increased for maximum efficiency. The period of rotation of the crankshaft between the ignition initiation and top dead center for the piston to begin the power stroke represents negative work by the engine. Therefore, this negative work offsets the positive work provided by the piston movement after top dead center. These data show that this effect is larger than the negative effect of higher thermal losses through the cylinder wall for the high swirl intake. Consequently, while a high swirl intake system may be preferred where fuel economy is of great importance, in those circumstances where air quality concerns, and in particular, NOx concerns outweigh fuel economy concerns, quiescent combustion is preferred.

What is claimed is:

1. A method of operating an internal combustion engine running on a gaseous fuel under diluted charge conditions to produce low NOx emissions, the method comprising:
selecting a gaseous fuel from the fuels consisting of methane, natural gas, propane, butane and combinations thereof;
introducing a mixture comprising the gaseous fuel and air into a substantially quiescent combustion chamber of the internal combustion engine under diluted charge conditions with a phi value of at least about 0.61 and at a substantially low angular momentum to prevent significant swirl or tumble; and
combusting the mixture within the combustion chamber.

2. The method of claim 1 wherein the angular momentum of the mixture introduced into the combustion chamber has a swirl ratio less than about 1.

3. The method of claim 1 wherein the angular momentum of the mixture introduced into the combustion chamber has a swirl ratio of about 0.5.

4. The method of claim 1 wherein the diluted charge conditions are achieved by mixing the fuel and air with a diluent selected from excess air, recirculated exhaust gas, water vapor, and combinations thereof.

5. The method of claim 1 further comprising:
producing an exhaust gas stream from the combustion of the mixture; and
mixing a portion of the exhaust gas stream with the gaseous fuel and air to form the mixture.

6. The method of claim 1 wherein the fuel is natural gas.

7. A method of operating an internal combustion engine comprising:
selecting a gaseous fuel from the fuels consisting of methane, natural gas, propane, butane and combinations thereof;
mixing the gaseous fuel with air and an exhaust gas recirculation stream to form a diluted charge fuel mixture with a phi value of at least about 0.61;
introducing the diluted charge fuel mixture into a substantially quiescent combustion chamber of the internal combustion engine at a substantially low angular momentum to prevent significant swirl or tumble; and
combusting the mixture within the combustion chamber.

8. The method of claim 7 wherein the angular momentum of the diluted charge fuel mixture introduced into the combustion chamber has a swirl ratio less than about 1.

9. The method of claim 7 wherein the angular momentum of the diluted charge fuel mixture introduced into the combustion chamber has a swirl ratio of about 0.5.

10. The method of claim 7 wherein the diluted charge fuel mixture further comprises excess air.

11. The method of claim 7 wherein the fuel is natural gas.

12. An internal combustion engine comprising:
a source of gaseous fuel selected from the fuels consisting of methane, natural gas, propane, butane and combinations thereof;
an intake manifold adapted to mix the gaseous fuel with air and a recycled exhaust gas stream and produce an diluted charge fuel mixture with a phi value of at least about 0.61;
at least one combustion chamber adapted to receive the diluted charge fuel mixture, burn the fuel, and produce an exhaust gas stream, wherein the intake manifold and combustion chamber are adapted to maintain a substantially low angular momentum for the air-fuel mixture within the combustion chamber; and
an exhaust gas conduit for removing the exhaust gas stream from the combustion chamber and recycling at least a portion of the exhaust gas stream to the intake manifold as the recycled exhaust gas stream.

13. The internal combustion engine of claim 12 wherein the at least one combustion chamber is defined by a piston, a cylinder, and a cylinder head.

14. The internal combustion engine of claim 12 comprising a plurality of combustion chambers.

15. The internal combustion engine of claim 14 wherein the plurality of combustion chambers are defined by a plurality of pistons, a plurality of cylinders, and at least one cylinder head.

16. The internal combustion engine of claim 15 wherein each cylinder includes at least one intake port through the cylinder head, the internal combustion engine further comprising an intake valve corresponding to each intake port, each intake valve including a valve stem, wherein each intake port is defined by at least one port wall substantially parallel to the corresponding valve stem.

17. The internal combustion engine of claim 15 wherein each piston defines a flat piston crown.

18. The internal combustion engine of claim 17 wherein each piston crown is substantially symmetrical about a central axis of the corresponding cylinder.

19. The internal combustion engine of claim 15 wherein each piston defines a dished piston crown.

20. The internal combustion engine of claim 19 wherein each piston crown is substantially symmetrical about a central axis of the corresponding cylinder.
